(19) United States
(12) Patent Application Publication
(10) Pub. No.: US 2019/0360522 A1
(43) Pub. Date: Nov. 28, 2019

(54) Device With A Turbocharger For Charging A Fuel Cell

(71) Applicant: MAN Energy Solutions SE, Augsburg (DE)

(72) Inventors: Jan-Christoph HAAG, Hirschberg (DE); Lutz AURAHS, Langweid (DE); Christoph HEINZ, Langenau (DE); Klaus BARTHOLOMÄ, Friedberg (DE)

(73) Assignee: MAN Energy Solutions SE

(21) Appl. No.: 16/421,062

(22) Filed: May 23, 2019

(30) Foreign Application Priority Data
May 24, 2018 (DE) 102018112460.0

(51) Int. Cl. F16C 17/04; H01M 8/04111; H01M 8/04746; H01M 8/22; F04B 25/00

(52) U.S. Cl. CPC F16C 17/042; H01M 8/04111; F04B 25/00; H01M 8/22; H01M 8/04753

(57) ABSTRACT

A device for air supply of a fuel cell operated with hydrogen, via a compressor of an exhaust gas turbocharger. The compressor is drive-effectively connected to a turbine of the turbocharger that can be driven by an exhaust gas flow of the fuel cell via a shaft and the turbocharger, is drive-effectively connected to a motor via the shaft. The mounting of the shaft of the turbocharger is formed by a gas or air-lubricated mounting.

### BACKGROUND OF THE INVENTION

### 1. Field of the Invention

The invention relates to a device with a turbocharger for charging a fuel cell, in particular a fuel cell operated with hydrogen.

### 2. Description of the Related Art

Conventionally, fuel cells are operated with pure hydrogen which in the fuel cell reacts to form water and electricity is released in the process. Usually, the hydrogen for this purpose is expanded out of a pressure vessel and fed to the fuel cell. The air necessary for the combustion in the fuel cell is drawn in from the surroundings by an electrically operated blower and fed to the fuel cell.

A generic prior art is described for example in DE 101 20 947 A1 or also in DE 10 2004 051 359 A1. In the automotive environment, fuel cells are known which are charged by turbochargers. The intake air in this case is drawn in by the compressor of a turbocharger and the exhaust gas generated during the combustion drives the turbine of the turbocharger. If required, additional electric energy can be fed to the shaft of the turbocharger by an electric motor in order to offset a thermodynamic imbalance of the two components.

Generally, turbochargers whose bearings are supplied with lubricating oil from the engine oil circuit are used in the prior art. Here, even minor oil leakages of the mounting result in a contamination of the fuel cell and an increased exhaust gas emission.

### SUMMARY OF THE INVENTION

An object of one aspect of the invention present here therefore consists in avoiding the mentioned disadvantages and to state a construction which is improved with regard to the operational reliability and tightness.

A basic idea of the invention consists in using a turbocharger, in particular an exhaust gas turbocharger, for the air supply of a fuel cell, wherein for the lubrication of the mounting of the turbocharger a gas or air is used. Preferentially, the air for the lubrication is to be extracted after the compressor. Alternatively, hydrogen can also be used which, after it has flowed through the relevant mounting, is again fed to the compressor at the inlet.

The risk of an exhaust gas contamination is thus eliminated and, through the lower bearing losses of the turbocharger, the efficiency of the same increased.

Using a gaseous lubricant requires a specific construction of the mounting of the turbocharger. According to one aspect of the invention, a device for the air supply of a fuel cell operated with hydrogen via a compressor of an exhaust gas turbocharger is proposed for this purpose, wherein the compressor is drive-effectively connected via a shaft to a turbine of the turbocharger that can be driven by an exhaust gas flow of the fuel cell and the turbocharger, furthermore, is drive-effectively connected to a motor via the shaft, wherein the mounting of the shaft of the turbocharger is formed by a gas or air-lubricated mounting.

In an advantageous configuration it is provided that the motor is an electric motor that is arranged between the compressor and the turbine.

It is advantageous, furthermore, when the stator of the motor with its stator windings is arranged round about the shaft of the turbocharger, wherein the shaft is formed as a part of the rotor of the motor.

The turbocharger, in which the shaft is designed with a large diameter, is particularly advantageously suited for use of a motor arranged between the two impellers, which further preferably can also be operated in the generator mode. Here, the shaft of the turbocharger simultaneously forms the rotor of the electric motor, as a result of which a high degree of component integration and compactness is achieved. In the case that hydrogen is used as lubricant, the same can be simultaneously used for cooling the motor windings and thus for its increase in efficiency.

In an advantageous configuration of the invention it is provided that on the one hand the mounting of the shaft on the compressor and preferably also the mounting of the shaft on the turbine is formed by a gas or air-lubricated radial bearing.

It is advantageous, furthermore, when the shaft is mounted on an axial thrust bearing by a thrust ring formed by the shaft or attached to the shaft. Because of the significantly lower viscosity of the gaseous lubricant (compared with oil), the bearing diameter of the radial bearings and also the outer diameter of the thrust bearing is formed significantly larger. Here, the thrust bearing has approximately the same outer diameter as the compressor wheel. The radial bearing diameter is obtained from the thrust bearing diameter and the area of the same that is required in order to be able to offset or absorb the axial thrust that occurs during the operation of the exhaust gas turbocharger.

It is advantageous, furthermore, when the axial thrust bearing is arranged in the axial direction out of center either on the compressor side or the turbine side of the shaft. On no account should this axial thrust bearing be positioned in the middle or approximately the middle of the shaft between the compressor and the turbine, since because of this the stator of the electric motor would have to be split. In this way, the shaft can be formed in one piece or as one part in the axial direction.

A further aspect of the present invention relates to the use of a device as described above for providing air for a fuel cell, which is part of a fuel cell system, via which electric drive power for a consumer, preferentially in the power range of >100 kW is provided.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Other advantageous further developments of the invention are marked in the subclaims or are shown in more detail by way of the figures together with the description of the preferred embodiment of the invention.

It shows:

FIG. 1 is a schematic diagram of an exemplary embodiment according to the invention; and

FIG. 2 is a schematic view of a detail of the exhaust gas turbocharger with an integrated electric motor.

### DETAILED DESCRIPTION OF THE PRESENTLY PREFERRED EMBODIMENTS

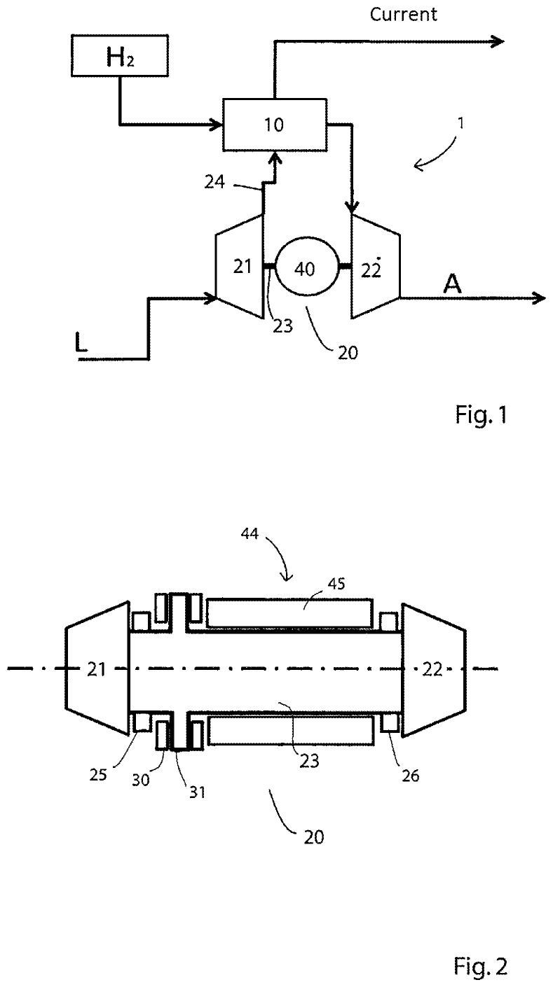

In the following, aspects of the invention are described in more detail by way of a preferred exemplary embodiment making reference to the FIGS. 1 and 2, wherein same reference numbers in the figures point to same structural and/or functional features.

In the shown exemplary embodiment, a fuel cell 10 and the device 1 for the air supply of the fuel cell 10 operated with hydrogen are shown. The device 1 comprises a compressor 21 of a turbocharger 20. The compressor 21 is drive-effectively connected to a turbine 22 of the turbocharger 20 that can be driven by an exhaust gas flow A of the fuel cell 10. The exhaust gas flow generated by the fuel cell 10 flows through the turbine 22 and, via the shaft 23, drives the compressor wheel of the compressor 21. In the process, the supply air for the fuel cell 10 is compressed by the compressor 21 and fed to the fuel cell 10 via the air supply passage 24.

In the exemplary embodiment according to FIG. 1, an electric motor 40 is provided, which can drive the compressor 21 via a drive shaft 23. To this end, the compressor wheel of the compressor 21 together with the turbine 22 is arranged on the common shaft 23. Here, the electric motor 40 is arranged within the turbocharger 20 out of center, namely on the compressor side between the compressor 21 and the turbine 22. The stator 44 of the motor 40 is arranged with its stator windings 45 round about the shaft 23 of the turbocharger 20, wherein from FIG. 2 it is evident that the shaft 23 itself is formed as a part of the rotor of the motor 40.

In the detail view according to FIG. 2, a detail of the mounting is shown. The mounting of the shaft 23 of the turbocharger 20 is formed by a gas-lubricated mounting and specifically on the compressor 21 and also on the turbine 22 by a gas or air-lubricated radial bearing 25 and 26 each. The shaft 23 is mounted on an axial thrust bearing 30 by a thrust ring 31 formed by the shaft 23. The outer diameter of the axial thrust bearing 30 is larger than the outer diameter of the compressor 21. The axial thrust bearing 30 is formed on the one-piece shaft 23 out of center in the axial direction.

If hydrogen is used as lubricant, a tight shaft seal by sealing air, piston ring, labyrinth, or membrane seal is to be provided on the turbine side. On the compressor side, by contrast, a shaft seal can be omitted since the hydrogen is again fed to the fuel cell for the combustion as intended.

In its embodiment, the invention is not restricted to the preferred exemplary embodiments stated above. On the contrary, a number of versions is conceivable which makes use of the shown solution even with fundamentally different types of embodiments.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A device for air supply of a fuel cell, comprising:
a motor;
a shaft;
a turbine of a turbocharger configured to be driven by an exhaust gas flow of the fuel cell;
a compressor of the turbocharger that is drive-effectively connected via the shaft to both the turbine and the motor; and
a mounting of the shaft is formed by one of a gas-lubricated mounting and an air-lubricated mounting.

2. The device according to claim 1, wherein the motor is an electric motor arranged between the compressor and the turbine.

3. The device according to claim 2, wherein a stator of the motor with its stator windings is arranged around about the shaft of the turbocharger, wherein the shaft is formed as a part of a rotor of the motor.

4. The device according to claim 1, wherein the mounting of the shaft on the compressor is formed by one of a gas-lubricated radial bearing and an air-lubricated radial bearing.

5. The device according to claim 1, wherein the mounting of the shaft on the turbine is formed by one of a gas-lubricated radial bearing and an air-lubricated radial bearing.

6. The device according to claim 1, wherein the shaft is mounted on an axial thrust bearing by a thrust ring that is one of formed by the shaft and attached to the shaft.

7. The device according to claim 6, wherein the thrust ring of the axial thrust bearing has a diameter that is one of a same as a diameter of a compressor wheel of the compressor and slightly larger than the diameter of the compressor wheel of the compressor.

8. The device according to claim 6, wherein the axial thrust bearing is arranged on the shaft in an axial direction out of a center either on a compressor side or on a turbine side.

9. The device according to claim 1, wherein the shaft is formed in one piece in an axial direction.

10. The device according to claim 1, wherein the device is configured to provide air for the fuel cell, which is part of a fuel cell system, via which electric drive power is provided for a consumer.

11. The device according to claim 1, wherein the fuel cell is operated with hydrogen.

12. The device according to claim 10, wherein the electric drive power is provided for the consumer in a power range of >100 kW.
